(19) United States
(12) Patent Application Publication
(10) Pub. No.: US 2024/0180202 A1
(43) Pub. Date: Jun. 6, 2024

(54) GRANULATED PRODUCT

(71) Applicant: TOYO SHINYAKU CO., LTD., Fukuoka (JP)

(72) Inventors: Hiroya TAKAHASHI, Saga (JP); Yoshifumi KOSEKI, Saga (JP)

(73) Assignee: TOYO SHINYAKU CO., LTD., Fukuoka (JP)

(21) Appl. No.: 18/367,757

(22) Filed: Sep. 13, 2023

(30) Foreign Application Priority Data
Dec. 6, 2022 (JP) 2022-194794

(51) Int. Cl. A23L 2/39; A23L 5/30; A23L 7/10; A23L 19/00

(52) U.S. Cl. CPC A23L 2/39; A23L 5/30; A23L 7/198; A23L 19/01

(57) ABSTRACT

It is to provide a granulated product comprising a dark-green vegetable, and having excellent dispersibility and drinkability.

According to the present invention, by using dark-green vegetable for granulation in the process of developing an oral composition comprising a dark-green vegetable, it is possible to provide a granulated product having excellent dispersibility and drinkability.

### CROSS-REFERENCE TO RELATED APPLICATIONS

This application claims benefit of Japanese Application No. 2022-194794 filed in Japan on Dec. 6, 2022, the contents of which are incorporated by this reference.

### BACKGROUND OF THE INVENTION

### Field of the Invention

The present invention relates to a granulated product comprising a dark-green vegetable.

### Description of the Related Art

Dark-green vegetables are known to comprise nutrient components, such as vitamins, minerals and dietary fiber in abundance. Thus, dark-green vegetables are used in various foods and drinks, such as health food, supplements, and beverages. For example, Patent Reference 1 describes mineral functional water comprising wormwood (Artemisia indica).

As form of health foods or supplements comprising dark-green vegetable, there are many processed foods in powdered state. As for processed foods in powdered state, there are some that are intake in state of powder as it is, while there are some that are intake as beverages, by being mixed to liquid such as water or hot water, milk, soy milk, etc. In the present application, processed foods in powdered state supplied for drink as beverage, by being mixed in liquid such as water or hot water, milk, soy milk, etc. by a consumer at the time of intake are called powder beverage.

When foods and drinks comprising dark-green vegetable are a powder beverage, the action of dispersing the powder beverage into liquid such as water is performed by the consumer by himself (herself) at the time of intake. So that the consumer can easily intake, development of powder beverage having excellent dispersibility (can be easily dispersed in liquid, etc.), and having good drinkability (with few tickle) was awaited. However, powder beverages comprising dark-green vegetables that have been developed so far did not necessarily have excellent dispersibility or drinkability. Particularly, when the content of the dark-green vegetable in the powder beverage is high, the dispersibility of the powder beverage was bad, and amelioration was awaited.

### PRIOR ART DOCUMENTS

<Patent document 1> US Patent Application Publication No. 2017/0118995

### SUMMARY OF THE INVENTION

### Technical Problem

The present invention has been made in view of the above-mentioned problems, and is intended to provide a granulated product comprising a dark-green vegetable, and having excellent dispersibility and drinkability.

### Solution to Problem

The present inventors have found out, in the process of developing an oral composition comprising a dark-green vegetable, that by granulating using dark-green vegetable, a granulated product having excellent dispersibility and drinkability can be obtained. The present invention has been thus completed.

Further, the present inventors have found out that by granulating dark-green vegetables by a fluidized-bed granulation, a granulated product having excellent dispersibility and drinkability can be obtained. The present invention has been thus completed.

Specifically, the present invention is as follows.

[1] A granulated product comprising a dark-green vegetable.
[2] The granulated product according to [1], wherein the dark-green vegetable is a dry powder.
[3] The granulated product according to [1], wherein the dark-green vegetable is a crushed powder.
[4] The granulated product according to [1], wherein the dark-green vegetable is a young barley grass.
[5] The granulated product according to [1], wherein the content of the dark-green vegetable in the granulated product is 10% by weight or more.
[6] The granulated product according t to [1], wherein the granulated product is for beverage.
[7] The granulated product according to [1], wherein the dark-green vegetable is at least one selected from oats, kale, ocarina, mulberry, Angelica keiskei, wormwood, Peucedanum japonicum, Kuma Bamboo Grass, spinach, Swiss chard, and celery.
[8] The granulated product according to [1], wherein the content of the dark-green vegetable in the granulated product is 10% by weight or more.
[9] The granulated product according to [1], wherein the content of the dark-green vegetable in the granulated product is 50% by weight or more.
[10] The granulated product according to [1], wherein the content of the dark-green vegetable in the granulated product is 80% by weight or more.
[11] The granulated product according to [1], wherein the content of the dark-green vegetable in the granulated product is 100% by weight.
[12] A method for producing a granulated product comprising a dark-green vegetable according to [1], comprising granulating the dark-green vegetable by a fluidized-bed granulation.
[13] A method for producing a granulated product comprising a dark-green vegetable according to [1], comprising a step of crushing the dark-green vegetable to obtain a crushed powder of dark-green vegetable, and a step of injecting the crushed powder of dark-green vegetable in a fluidized-bed granulator, supplying air for fluidization, spraying water, and then drying to obtain a granulated product.

### Advantageous Effects of Invention

According to the present invention, by producing a granulated product using dark-green vegetable, a granulated product having excellent dispersibility and drinkability can be provided.

### DESCRIPTION OF EMBODIMENTS

The present invention is explained in detail in the following.

### [1. Dark-Green Vegetables]

The dark-green vegetables of the present invention relate to vegetables having green color, specifically include green leaves of plants such as oats, kale, ocarina, mulberry, Angelica keiskei, wormwood, Peucedanum japonicum, Kuma Bamboo Grass, spinach, Swiss chard, celery, cabbage, colored green, lettuce, carrot, and tea, and vegetables such as pepper, goya, Japanese mustard spinach, green onion, Chinese chive, Broccoli, and peas. Parts of dark-green vegetables used in the present invention are not limited as long as it includes parts having green color, and for example, leaves, stem, and berries can be used.

As dark-green vegetables of the present invention, plants belonging to any family can be used, and for examples plants of Granmineae, Brassicaceae, Amaranthaceae, Apiaceae, Convolvulaceae, Moraceae, Asteraceae, and Chenopodiaceae can be used. From the viewpoint of having excellent dispersibility and drinkability when used as powder beverage, and the viewpoint of comprising nutrient components in abundance, plants of Granmineae, Brassicaceae, Amaranthaceae, Apiaceae are more preferable, plants of Granmineae, Brassicaceae, Amaranthaceae are particularly preferable, and plants of Granmineae are most preferable.

As dark-green vegetables of the present invention, plants belonging to any genus can be used, and for examples plants of Granmineae Hordeum, Granmineae Sasa, Brassicaceae Brassica, Amaranthaceae Spinacia, Apiaceae Angelica, Apiaceae Peucedanum, Apiaceae Apium, Convolvulaceae Ipomoea, Moraceae Morus, Asteraceae Artemisia, Chenopodiaceae Beta, etc. can be used. From the viewpoint of having particularly excellent dispersibility and drinkability when used as powder beverage, and the viewpoint of comprising nutrient components in abundance, plants of Granmineae Hordeum, Granmineae Sasa, Brassicaceae Brassica, Amaranthaceae Spinacia are more preferable, plants of Granmineae Hordeum, Granmineae Sasa, Brassicaceae Brassica, Amaranthaceae Spinacia are more preferable, and plants of Granmineae Hordeum are most preferable.

### [2. Green Leaves of Specific Plants]

As dark-green vegetables of the present invention, any dark-green vegetables can be used. However, from the viewpoint of having particularly excellent dispersibility and drinkability when used as powder beverage, and the viewpoint of comprising nutrient components in abundance, it is particularly preferable to use green leaves of specific plants as described in the following as dark-green vegetables. Specific plants of the present invention mean at least one plant selected from oats, kale, ocarina, mulberry, Angelica keiskei, wormwood, Peucedanum japonicum, Kuma Bamboo Grass, spinach, Swiss chard and celery. Only one type can be used, but two or more types can be also used. From the viewpoint of having particularly excellent dispersibility and drinkability when used as powder beverage, and the viewpoint of comprising nutrient components in abundance, among green leaves of specific plants, green leaves of oats are particularly preferable, and green leaves of barley (young barley grass) are most preferable.

Green leaves of specific plants of the present invention relate to plant body including leaf part of the specific plant, and can include leaves, as well as stem, or other parts. Since it takes effort to remove stem from the aerial part at the time of harvest, and the stem part also comprises nutrient components such as insoluble dietary fiber, etc. in abundance, from the viewpoint of reducing manufacturing cost and the viewpoint of alibility, it is preferable to comprise stem together with leaves.

### <Oats>

Oats of the present invention mean a collective term of gramineous plant having similar appearance, such as barley, wheat, rye, oat, etc. As oats of the present invention, barley is particularly preferable.

Barley (Hordeum vulgare L.) is said to be native of Central Asia, is a poaceous annual or biennial grass plant belonging to Granmineae Hordeum. As barley used in the present invention, breed is not particularly limited. Barley of any breed can be used, and even wild species or crossbred can be used. For example, two-row barley, six-row barley, naked barley etc. can be exemplified, and these can be used by combining one or more breeds.

Green leaves of oats can be any one harvested at any harvest season, and are not particularly limited. For example, when oats are barley, it is preferable to use those harvested before mature stage, specifically those harvested from initiation of tillering stage to before initiation of ear emergence (young barley grass). Specifically, it is preferable to use young barley grass harvested from barley having a height of 10 cm or more, preferably about 10 to 90 cm, particularly preferably about 20 to 80 cm, best of all about 30 to 70 cm.

### <Kale>

Kale of the present invention means a plant of Brassicaceae Brassica, which scientific name is Brassica oleracea var. acephala. Breed of kale is not particularly limited, and various types of kale such as Kitchen Kale, Tree Kale, Bush Kale, Marrow Kale, Collard (can be referred to as collard green), Green leaf kale, etc. can be used. Green leaves of kale can be any one harvested at any harvest season, and are not particularly limited.

### <Ocarina>

Ocarina of the present invention means a plant of Convolvulaceae Ipomoea, which scientific name is Ipomea batatas. Ocarina is not particularly limited as long as it is one generally called sweet potato. Breed of ocarina is not particularly limited, and for example, breeds such as Suio, Joy White, Kogane-sengan, Shiroyutaka, Satsuma starch, Ayamurasaki can be exemplified. Among these, Suio having a high polyphenol content is preferable. Green leaves of ocarina can be any one harvested at any harvest season, and are not particularly limited. Tip part of stem and leaf (young stem and leaf) is preferable, and young stem and leaf in a state maintaining yellow-tinged green color is further preferable.

### <Mulberry>

Mulberry of the present invention means a plant of Moraceae Morus (genus Morus). Species of mulberry are not particularly limited, and Morus alba, Morus Australia, Morus lhou, Morus laevigata, Morus tiliaefolia, Morus boninensis, Morus serrata, etc. can be used. Green leaves of mulberry can be any one harvested at any harvest season, and are not particularly limited.

<Angelica keiskei>

Angelica keiskei of the present invention means a plant of Apiaceae Angelica. Breed of Angelica keiskei is not particularly limited and can be appropriately used. Green leaves of Angelica keiskei can be any one harvested at any harvest season, and are not particularly limited.

### <Wormwood>

Wormwood of the present invention means perennial plant of Asteraceae Artemisia (genus Artemisia). Species of wormwood are not particularly limited, and Artemisia indica, Artemisia absinthium, Artemisia dracunculus, Nitrof wormwood, Artemisia congesta, Artemisia capillaris, Artemisia japonica, Artemisia scoparia, Artemisia apiacea, Artemisia annua, Artemisia keshkeana, Artemisia pedenculosa, Artemisia trifucata, Artemisia arctica, Artemisia sinanensis, Artemisia glomerata, Artemisia lacinata, Artemisia stelleriana, Artemisia iwayomogi, Artemisia feddei, Artemisia gilvescens, Artemisia dubia, Artemisia monophylla, Artemisia unalaskensis, Artemisia koidzumii, Artemisia stolonifera, Artemisia momiyamae, Artemisia ruburipes, Artemisia montana, Artemisia indica, Artemisia schmidtiana, Artemisia kitadakensis, etc. can be used. Among these, Artemisia indica is particularly preferable. Green leaves of Artemisia indica can be any one harvested at any harvest season, and are not particularly limited.

<Peucedanum japonicum>

Peucedanum japonicum of the present invention means a plant of Apiaceae Pternopetalum. Peucedanum is called Danboufu, Chomeiso, Chomeigusa, Chomifusa, Bofu, Sakuna, Ububasafuna, Chomigusa, Botanbofu depending on the region. Breed of Peucedanum japonicum is not particularly limited, and can be appropriately used. Green leaves of Peucedanum japonicum can be any one harvested at any harvest season, and are not particularly limited.

### <Kuma Bamboo Grass>

Kuma Bamboo Grass of the present invention means a plant of Sasa beitchii (genus Sasa). Species of Kuma Bamboo Grass are not particularly limited, and Sasa veitchii, Sasa kurilensis, Sasamorpha borealis, Sasa senanensis, Sasa palmata, Sasa niponica, etc. can be used. Green leaves of Kuma Bamboo Grass can be any one harvested at any harvest season, and are not particularly limited.

### <Spinach>

Spinach of the present invention means a plant of Amaranthaceae Spinacia, which scientific name is Spinacia oleracea. Breed of spinach is not particularly limited, and can be appropriately used. Green leaves of spinach can be any one harvested at any harvest season, and are not particularly limited.

<Swiss chard>

Swiss chard of the present invention means a plant of Chenopodiaceae Beta, which scientific name is Beta vulgaris. In Japan, it is also called Fudanso. Breed of Swiss chard is not particularly limited, and can be appropriately used. Green leaves of Swiss chard can be any one harvested at any harvest season, and are not particularly limited.

### <Celery>

Celery of the present invention means a plant of Apiaceae Apium, which scientific name is Apium graveolens. Breed of celery is not particularly limited, and can be appropriately used. Green leaves of celery can be any one harvested at any harvest season, and are not particularly limited.

### [3. Dry Powder of Dark-Green Vegetables]

As dark-green vegetables used for the granulated product of the present invention, for example, dry powder of dark-green vegetables can be used. Dry powder of dark-green vegetable of the present invention means those made by processing dark-green vegetables and dried and powderized. Examples of dry powder of dark-green vegetables include those made by crushing dark-green vegetables and dried and powderized (crushed powder of dark-green vegetables), those made by drying and powderizing juice of dark-green vegetables (juice powder of dark-green vegetables), and those made by drying and powderizing extract of dark-green vegetables (extract powder of dark-green vegetables), but it is not limited to these. As dry powder of dark-green vegetables of the present invention, it is preferable to be crushed powder of dark-green vegetables from the viewpoint of having excellent dispersibility and drinkability, the viewpoint of easiness of processing, storage, transport, etc. and the viewpoint of comprising dietary fiber in abundance.

As crushed powder of dark-green vegetables of the present invention, those obtained for example by combining drying treatment and crushing treatment can be used. Drying treatment and crushing treatment can be performed at the same time, or either one can be performed before the other one. However, it is preferable to first perform drying treatment, and then perform crushing treatment. According to need, one or more treatments selected from treatment such as blanching treatment and disinfection treatment can be performed in combination. The number of times for performing crushing treatment is not particularly limited, and it can be performed as one or more treatments, such as after performing coarse crushing treatment, performing fine crushing for crushing more finely.

Blanching treatment is a treatment to keep the green color of dark-green vegetables of the specific plant bright, and examples of a method of blanching treatment include hot-water treatment and steaming treatment.

Examples of hot-water treatment include a method of treating dark-green vegetables in hot water or moisture of for example 70 to 100° C., preferably 80 to 100° C., for 60 to 240 sec, preferably for 90 to 180 sec. As steaming treatment, an intermittent steaming treatment of repeating a treatment of steaming dark-green vegetables with moisture and a treatment of cooling at normal pressure or under pressure is preferable.

Disinfection treatment is not particularly limited as long as it is a disinfection treatment commonly known to a person skilled in the art. For example, it can be a treatment of killing microorganisms physically or chemically by using temperature, pressure, electromagnetic wave, drugs, etc.

When performing blanching treatment additionally to drying treatment and crushing treatment, it is preferable that blanching treatment: performed before drying treatment. Further, when performing disinfection treatment additionally to drying treatment and crushing treatment, it is preferable that disinfection treatment is performed after drying treatment, or before or after crushing treatment.

Drying treatment is not particularly limited, but examples include treatment of drying so that the water content of dark-green vegetables becomes 10% by weight or less, preferably 8% by weight or less.

Crushing treatment is not particularly limited, but examples include treatment of crushing plant bodies by an arbitrary method that a person skilled in the art commonly uses. When performing crushing treatment, it is preferable to perform the treatment by combining coarse crushing and fine crushing, from the viewpoint of increasing crushing efficiency, such as to make the particle size uniform, shortening the crushing time, etc.

As juice powder of dark-green vegetables of the present invention, for example, those obtained by concentrating juice of dark-green vegetables at low temperature to concentrate the solid content, and lyophilizing or spray drying the concentrated liquid can be used.

### [4. Granulated Product Comprising Dark-Green Vegetables]

Granulation means an operation of agglomerating plural particles, to form an aggregate. In the aggregate (granulated product), a void is formed between particles when particles agglomerate, and there is a structural difference between granulated product and particles of raw materials used for granulation. Granulated products can be further mixed with raw materials other than dark-green vegetables of specific plant such as excipient and sweetener. The granulated product of the present invention is not particularly as long it is an agglomerate in which plural particles are agglomerated by some method, and the size of granulated product is not particularly limited.

As for granulation method of the present invention, it is not particularly limited and a granulation method that a person skilled in the art commonly uses should be appropriately selected. For example, fluidized-bed granulation, extrusion granulation, tumbling granulation, and stirring granulation, can be exemplified. With any granulation method, granulated products can be produced by using an arbitrary granulation apparatus available in the market, and by appropriately setting various production conditions such as drying temperature, etc. From the viewpoint of easiness of granulation, and obtaining granulated product having excellent dispersibility, fluidized-bed granulation is particularly preferable. Fluidized-bed granulation is a method of applying air to powder particles being the raw material to fluidize by aerial flow, while spraying coupling liquid such as water to attach powder particles to each other, to form a granulated product being agglomerate of powder particles.

In case of fluidized-bed granulation, according to a production method comprising a step of injecting dark-green vegetables to be the raw material in a fluidized-bed granulator, spraying water on the raw material having been fluidized by supplying air, and then drying to obtain a granulated product, the granulated product of the present invention can be obtained. As fluidized-bed granulator used for granulation, an arbitrary granulator available in the market can be used.

The granulated product of the present invention can be appropriately added with additives such as binding agent, excipient, thickening agent, etc. according to need additionally to dark-green vegetables. The types of additives are not particularly limited, and examples include, for example, sugars such as glucose, maltitol, erythritol, etc., polysaccharide thickeners such as guar gum, etc., starch such as corn starch, etc., starch degradant such as dextrin and non-digestible dextrin, etc. Only one type of additive can be added, or two or more types can be added.

The content of dark-green vegetable of specific plant in the granulated product of the present invention is not particularly limited. Conventionally, when a lot of dark-green vegetable (particularly crushed powder of green leaves of specific plant) was contained, granulation was difficult, and even when dark-green vegetables could be granulated, there was no benefit such as improving dispersibility, and it was thought to just increasing the manufacturing cost. Therefore, processed foods in powdered state that have not been granulated, by only mixing dry powder of dark-green vegetable with other raw materials were commercially available. However, the present inventors have found out that even in case of containing crushed powder of dark-green vegetables at a high content, by granulating by fluidized-granulation, it is possible to granulate, and that granulated products having excellent dispersibility or drinkability can be obtained. When the content of dark-green vegetable of specific plant in the granulated product is high, there is a merit that more dark-green vegetable can be intake, as compared to when the content is low, even if the total amount of granulated product that is orally intake is the same. From the viewpoint that nutrient components can be efficiently intake, it is preferable that the content of dark-green vegetable in the granulated product is high, and for example, as dry weight, it can be 10% by weight or more, preferably 20% by weight or more, more preferably 30% by weight or more, further more preferably 50% by weight or more, furthermore more preferably 80% by weight or more, particularly preferably 90% by weight or more, and most preferably 100% by weight. Similarly, from the viewpoint that nutrient components can be efficiently intake, it is preferable that among the raw materials mixed in the granulated product, the content of dark-green vegetable is the highest.

Among the dark-green vegetables, green leaves of oats have particular excellent taste and nutrition, it is preferable that among the raw materials mixed in the granulated product of the present invention, the content of green leaves of oats is the highest.

### <Oral Composition>

The granulated product of the present invention can be used as an oral composition. The form of oral composition is not particularly limited, and for example, foods and drinks, quasi-drugs and drug medicines, etc. can be exemplified. However, from the viewpoint of intaking dark-green vegetables on a daily basis to supplement daily nourishment, it is preferable to use as foods and drinks composition. The form of foods and drinks composition is not particularly limited, and examples include foods indicated with functionality, foods for specified health use, health foods, etc. can be exemplified.

Since the granulated product of the present invention has a characteristic of being easily dispersed in a medium such as water, it is preferable to use as a granulated product for beverage. A granulated product for beverage means a granulated product (powder beverage being a granulated product) served for drinking as a beverage, being mixed in a liquid such as water or hot water, milk, soy milk, etc. at the time of intake by the consumer. The granulated product for beverage has a merit of having a light weight and can be easily carried, as compared to beverages.

### EXAMPLES

In the following, the present invention is further explained with the Examples. However, the present invention is not limited to these Examples, and as long as the object of the invention can be solved, the present invention can have various embodiments.

### 1. Assessment of Dispersibility and Drinkability

### 1.1 Production of Examples and Comparative Examples

### Example 1

Young barley grass powder (young barley grass subjected to crushing treatment to be powderized) was injected in a fluidized-bed granulator, then to young barley grass powder that has been in a fluidized state, water was sprayed. Then, by drying with hot air, granulated product (water content 5% by weight or less) of Example 1 was obtained.

### Comparative Example 1

Young barley grass powder (those used in Example 1) that has not been granulated was used as Comparative Example 1.

### Example 2

Raw material mixed so that it becomes: young barley grass powder (those used in Example 1): 80% by weight, xylo-oligosaccharide 5% by weight; lactose 15% by weight; was injected in a fluidized-bed granulator, then to raw material that has been in a fluidized state, water was sprayed. Then, by supplying hot air for drying, granulated product (water content 5% by weight or less) of Example 2 was obtained.

### Example 3

Raw material mixed so that it becomes: young barley grass juice powder (extract juice of young barley grass added with dextrin, and dried for powderization by spray drying; ratio of extract juice of young barley grass and dextrin: 1:1): 60% by weight, reduced oligosaccharide 40% by weight; was injected in a fluidized-bed granulator, then to raw material that has been in a fluidized state, water was sprayed. Then, by drying with hot air, granulated product (water content 5% by weight or less) of Example 3 was obtained.

### Example 4

Kale powder (kale subject to crushing treatment to be powderized) was injected in a fluidized-bed granulator, then to kale powder that has been in a fluidized state, water was sprayed. Then, by drying with hot air, granulated product (water content 5% by weight or less) of Example 4 was obtained.

### Example 5

Angelica keiskei powder (Angelica keiskei subject to crushing treatment to be powderized) was injected in a fluidized-bed granulator, then to Angelica keiskei powder that has been in a fluidized state, water was sprayed. Then, by drying with hot air, granulated product (water content 5% by weight or less) of Example 5 was obtained.

### 1-2 Assessment of Dispersibility

By the method described in the following, the dispersibility of Examples and Comparative Example was assessed.

(1) Dispersibility when Injecting Sample in Water

3 g of each sample was gently injected in a drinking cup (height 100 mm, diameter of the upper part 75 mm, diameter of the bottom part 55 mm) filled with 100 ml of water. The time from when the sample is injected to when the whole sample is submerged in water to be dispersed in water (from the state of floating on the liquid surface until it sinks down in water) was measured as dispersion time. The hydrophilicity (water amenity) was assessed according to the following standard.

### <Standard>

∘: dispersion time less than 60 sec
x: dispersion time 60 sec or more
   (2) Dispersibility when Injecting Water to Sample

100 ml of water was gently injected in a drinking cup (height 100 mm, diameter of the upper part 75 mm, diameter of the bottom part 55 mm) added with 3 g of each sample. Then, water surface was observed, and the presence or absence of floating powder was assessed according to the following standard.

### <Standard>

Yes: at least a part of the sample is foating on the water surface
No: no sample is floating on the water surface (dispersed or sink down in water)

### (3) Assessment of Dispersion Stability

3 g of each sample was injected to a transparent, cylindrical (diameter 75 mm) drinking cup filled with 100 mL of water, and stirred 10 times (stirring rate: 1-1.5 times/sec) using a swizzle stick. Since each sample is insoluble, it is temporarily dispersed in water by stirring, while it is gradually sedimented with the course of time, and a clear part (clear upper portion) is formed on the upper part. After allowing to stand still for 1 min after stirring is terminated, the content of the drinking cup was observed, the height of the clear upper portion (separation distance) was measured. The dispersion stability was assessed according to the following standard. It means that shorter is the separation distance, the sample is dispersed in a stable state, and that it is hardly separated.

### <Standard>

∘: Separation distance less than 5 mm
x: Separation distance 5 mm or more

### (4) Overall Assessment of Dispersibility

Based on the results of (1) to (3), the overall assessment of the dispersibility was made according to the following standard.

### <Overall Assessment of Dispersibility>

∘: in case of: (1) hydrophilicity “o”, (2) presence of absence “O” of floating powder “no”, (3) dispersion stability
x: other cases

### 1-3. Assessment of Drinkability (Feeling of Going Down)

3 g of each sample was injected in a drinking cup filled with 100 ml of water. After injection, it was stirred 10 times (stirring rate: 1 to 1.5 times/sec) using a swizzle stick. Immediately after, each beverage was intake, and the feeling of going down was assessed using the following standard.

### <Standard>

∘: do not feel any tickle or almost no tickle in the throat when drinking
x: feel tickle in the throat when drinking

### 1-4. Results

The assessment results for dispersibility and drinkability are shown in Table 1. As apparent from Table 1, as compared to young barley grass powder that has not been granulated (Comparative Example 1), granulated products (Examples 1-5) comprising young barley grass powder, young barley grass juice powder, kale powder, or Angelica keiskei powder had excellent dispersibility. From these results, it has been revealed that according to the present invention, granulated products having excellent dispersibility and drinkability could be obtained.

TABLE 1

| | | Example | Comparative | Example | Example | Example | Example |
|---|---|---|---|---|---|---|---|
| | | 1 | Example 1 | 2 | 3 | 4 | 5 |
| Raw | Young barley grass power | 100.0 | 100.0 | 80.0 | | | |
| materials | Young barley grass | | | | 60.0 | | |
| | juice powder | | | | | | |
| | Kale powder | | | | | 100.0 | |
| | Angelica keiskei powder | | | | | | 100.0 |
| | Xylo-oligosaccharide | | | 5.0 | | | |
| | Lactose | | | 15.0 | | | |
| | Reduced oligosaccharide | | | | 40.0 | | |
| | Total (% by weight) | 100.0 | 100.0 | 100.0 | 100.0 | 100.0 | 100.0 |
| Presence or absence of granulation | | Yes | No | Yes | Yes | Yes | Yes |
| Dispersibility | Hydrophilicity | ◯ | X | ◯ | ◯ | ◯ | ◯ |
| | Presence or absence of | No | Yes | No | No | No | No |
| | floating powder | | | | | | |
| | Dispersion stability | ◯ | ◯ | ◯ | ◯ | ◯ | ◯ |
| | Overall Assessment | ◯ | X | ◯ | ◯ | ◯ | ◯ |

| | | | | | | |
|---|---|---|---|---|---|---|
| Feeling of going down | ◯ | ◯ | ◯ | ◯ | ◯ | ◯ |

### [2. Assessment of Ease of Handling]

3 g of sample of Example 1 or Comparative Example 1 was filled in aluminum pouch sachets. By using sachets filled with sample, the swirling of powder when opening the sachet, the powder fluidity when injecting in the drinking cup (index of ease of handling) were assessed according to the standard, to confirm the ease of handling. The results are shown in Table 2.

### <Standard>

### Swirling of Powder at the Time of Opening

∘: Few swirling of powder at the time of opening the sachet
x: Lot of swirling of powder at the time of opening the sachet Power fluidity when injecting
∘: Power fluidity when injecting in the drinking cup is smooth
x: Power fluidity when injecting in the drinking cup is not smooth

TABLE 2

| | | Comparative |
|---|---|---|
| | Example 1 | Example 1 |
| Swirling of powder at the time of opening | ◯ | X |
| Power fluidity when injecting | ◯ | X |

As it is apparent from Table 2, the granulated product of young barley grass powder (Example 1) was superior in ease of handling as compared to young barley grass powder that has not been granulated (Comparative Example 1).

### 3. Production of Granulated Product Comprising Green Leaves of Specific Plant

By the method described in the following, granulated products comprising green leaves of specific plant were obtained.

### Example 6

Mulberry leaf powder (obtained by powderizing mulberry leaf by subjecting to crushing treatment) was injected in a fluidized-bed granulator, then to mulberry leaf powder that has been in a fluidized state, water was sprayed. Then, by drying with hot air, granulated product (water content 5% by weight or less) of Example 6 was obtained.

### Example 7

Wormwood powder (obtained by powderizing wormwood by subjecting to crushing treatment) was injected in a fluidized-bed granulator, then to wormwood powder that has been in a fluidized state, water was intermittently sprayed. Then, by supplying hot air for drying, granulated product (water content 5% by weight or less) of Example 7 was obtained.

### Example 8

Peucedanum japonicum powder (obtained by powderizing Peucedanum japonicum by subjecting to crushing treatment) was injected in a fluidized-bed granulator, then to Peucedanum japonicum powder that has been in a fluidized state, water was sprayed. Then, by supplying hot air for drying, granulated product (water content 5% by weight or less) of Example 8 was obtained.

### Example 9

Kuma Bamboo Grass powder (obtained by powderizing Kuma Bamboo Grass by subjecting to crushing treatment) was injected in a fluidized-bed granulator, then to Kuma Bamboo Grass powder that has been in a fluidized state, water was sprayed. Then, by drying with hot air, granulated product (water content 5% by weight or less) of Example 9 was obtained.

### Example 10

Spinach powder (obtained by powderizing spinach by subjecting to crushing treatment) was injected in a fluidized-bed granulator, then to spinach powder that has been in a fluidized state, water was sprayed. Then, by drying with hot air, granulated product of Example 10 (water content 5% by weight or less) was obtained.

### Example 11

Celery powder (obtained by powderizing celery by subjecting to crushing treatment) was injected in a fluidized-bed granulator, then to celery powder that has been in a fluidized state, water was sprayed. Then, by drying with hot air, granulated product (water content 5% by weight or less) of Example 11 was obtained.

The granulated products of Examples 6 to 11 all had excellent dispersibility and feeling of going down.

### INDUSTRIAL APPLICABILITY

Since the granulated product of the present invention comprises a dark-green vegetable, and is a granulated product having excellent dispersibility and drinkability, it can be used as foods and drink as granulated product for beverage, and is the industrial applicability is high.

What is claimed is:

1. A granulated product comprising a dark-green vegetable.

2. The granulated product according to claim 1, wherein the dark-green vegetable is a dry powder.

3. The granulated product according to claim 1, wherein the dark-green vegetable is a young barley grass.

4. The granulated product according to claim 1, wherein the dark-green vegetable has a content of 10% by weight or more.

5. The granulated product according to claim 1, wherein the granulated product is for beverage.

6. A method for producing a granulated product comprising a dark-green vegetable, comprising granulating the dark-green vegetable by fluidized-bed granulation.
